(19) United States
(12) Patent Application Publication
(10) Pub. No.: US 2026/0262867 A1
(43) Pub. Date: Sep. 10, 2026

(54) Cookware Device

(71) Applicant: Rahman Mawload Ahmad, London (GB)

(72) Inventor: Rahman Mawload Ahmad, London (GB)

(21) Appl. No.: 19/167,191

(22) PCT Filed: Mar. 20, 2024
(86) PCT No.: PCT/GB2024/050752

§ 371 Date: Sep. 19, 2025

(30) Foreign Application Priority Data
Mar. 22, 2023 (GB) 2304136.1
Jun. 6, 2023 (GB) 2308419.7
Oct. 27, 2023 (GB) 2316486.6

(51) Int. Cl. A47J 27/10; A47J 27/04

(52) U.S. Cl. CPC A47J 27/10; A47J 27/04; A47J 2027/043

(57) ABSTRACT

A cookware device (10) comprising a food-receiving container (12) and a liquid-receiving container (14), a liquid-receiving volume (42) being defined therebetween. A liquid reservoir (16) is liquidly communicated with the liquid-receiving volume (42) by a port. The port is openable and closeable by a valve (28) so that a liquid level in the liquid-receiving volume (42) is maintainable.

The present invention relates to a cookware device, and in particular to a cooking pot.

Cooking food can result in carcinogens forming thereon or therein. For example, cooking food at temperatures above around 120° C. may result in the formation of polycyclic aromatic hydrocarbons, heterocyclic amines, and/or acrylamides.

Consumption of such compounds has the potential to increase the risk of developing cancer.

Therefore, to reduce such a risk, it is desirable to cook food at a temperature of less than 120° C.

At atmospheric pressure, water boils at 100° C. Therefore, it would be thought that boiling food would reduce the risk of producing such carcinogens, since the temperature of the food in the water should not rise above 100° C.

However, when boiling food, the bottom of the pot or pan, which is over the heat source, may reach a very high temperature. This temperature may be well in excess of 120° C. As such, food which contacts this surface may also reach temperatures above 120° C., and therefore increase the risk of producing carcinogenic compounds.

A bain-marie, also known as a water bath or double boiler, can be used to reduce the temperature of the bottom of the container which holds the food. However, bain-maries can be awkward and time-consuming to use, and do not offer energy savings over regular cookware.

The present invention seeks to provide a solution to these problems.

According to a first aspect of the present invention, there is provided a cookware device comprising: a food-receiving container for receiving food for cooking, the food-receiving container having a food-receiving-container wall; a liquid-receiving container which has a liquid-receiving-container wall, the food-receiving container being receivable by the liquid-receiving container to define a liquid-receiving volume between the food-receiving-container wall and the liquid-receiving-container wall; a liquid reservoir for holding liquid, the liquid reservoir being liquidly communicated with the liquid receiving volume by a port, the port being closeable by a valve.

Since a liquid receiving volume is defined outside of the food-receiving container, the food receiving container is prevented or limited from reaching temperatures in excess of 100° C. during normal use. This prevents or limits the formation of carcinogens in the food. Since there is a liquid reservoir, the liquid-receiving volume may be automatically refilled when the liquid therein has been depleted. This ensures the continued functioning of the device.

The liquid reservoir may also act as a heat-sink or heat-store, for retaining heat energy, since it may normally be filled with water, which has a good specific heat capacity. As such, the cookware device may be quicker and more efficient to reheat during subsequent uses, since some heat energy may be retained between uses. Furthermore, since the liquid-receiving volume has only a small volume, the cookware device may be heated quickly and more efficiently than boiling a large pan of water, for example.

Preferably, the valve may be a floating valve so that the port is closed when a given volume of liquid is received in the liquid receiving volume. This prevents the liquid receiving volume from being overfilled, whilst still allowing for a sufficient amount of liquid to be received in the liquid reservoir. When the liquid level in the liquid receiving volume is reduced below a given level, the valve may open the port to permit refilling.

Beneficially, the liquid receiving volume may be in fluid communication with an interior of the food-receiving container. As such, steam may be transferred between the liquid receiving volume and the food-receiving container, to help steam the food or otherwise transfer heat energy thereto by convection.

Advantageously, said fluid communication may be via an opening at or adjacent to an in-use top of the food-receiving container, and a duct which extends to an interior of the food-receiving container.

In a preferable embodiment, said fluid communication may be closeable via a floating valve in the food-receiving container. As such, when the liquid level in the food-receiving container becomes undesirably high, the fluid communication may be closed to prevent further steam entering the food-receiving container and condensing to form more liquid.

Optionally, the cookware device may further comprise a further port between the liquid reservoir and the liquid receiving volume, said further port being closed by a pressure relief valve to allow venting of vapour from the liquid receiving volume into the liquid reservoir. This prevents or limits the over-pressurisation of the liquid receiving volume.

Preferably, the pressure relief valve comprises a pivotable flap, the pivotable flap configured to close the further port when the pressure of vapour from the liquid receiving volume is less than the pressure in the liquid reservoir at the pivotable flap, and open the further port when the pressure of vapour from the liquid receiving volume is greater than the pressure in the liquid reservoir at the pivotable flap.

Beneficially, the pressure relief valve comprises an open-topped container configured to act as a biasing means for biasing, or configured to bias, the pivotable flap to an open condition when a level of liquid falls below the pressure relief valve in the liquid reservoir.

Advantageously, the device may further comprise a vapour flow path from the food-receiving container to the liquid reservoir to define a vapour return route. The vapour flow path is separate to the port which allows refilling of the liquid receiving volume, and the port which allows for pressure relief. The vapour return route allows for the efficient storage of heat, since energy may move from the food-receiving container to the liquid reservoir via the movement of vapour or by convection more generally.

As the water boils, water vapour in the form of steam is created which instead of entirely exiting the system at least in part flows along the vapour return path. Energy is advantageously conserved and the overall system is therefore more energy efficient. Further, the steam may condense back to water and refill the liquid reservoir for the water to be used again in cooking. In a preferable embodiment, the vapour return route includes a vapour diffuser. The vapour diffuser may otherwise be referred to as a vapour distributor or pressuriser. The vapour diffuser is preferably at or adjacent to a bottom of the liquid reservoir, so that it may be submerged in the liquid therein during use.

Optionally, the cookware device may further comprise a lid for closing the food-receiving container, the vapour flow path being at least partly defined by an interior facing surface of the lid. The lid prevents or restricts the water vapour or steam from escaping the system so that the heat energy can be stored. Additionally, the rate of manually refilling the liquid reservoir with water by the user is reduced.

Preferably, the liquid reservoir may include an opening in an in-use upper surface thereof and a conduit which extends therefrom and to at least an in-use lower half of the liquid reservoir, the device configured so that the lid is positionable across the food-receiving container and said opening to at least partly define the vapour flow path.

Additionally, the cookware device may further comprise a plurality of heat exchanger elements on at least any one of an outer surface of the liquid-receiving-container wall, an inner surface of the liquid-receiving-container wall, and an outer surface of the food-receiving-container wall.

Advantageously, each heat exchanger element may comprise a pyramidal protrusion. The protrusions provide a large surface area so that the heat transfers faster across the surface of the protrusions. Thus, the water is heated more efficiently.

Beneficially, the liquid-receiving container may comprise a wall surrounding at least part of an exterior surface of a base thereof for encouraging hot air to distribute across the exterior surface of the base.

In a preferable embodiment, the liquid-receiving volume may comprise a wall surrounding an interior surface of a base thereof for encouraging hot liquid to distribute across the interior surface of the base.

Optionally, the or each wall comprises at least one opening therein.

Preferably, a space may be defined between the liquid-receiving container and the liquid reservoir, the port being at a conduit which bridges the space.

Advantageously, the space may include a breather for ventilating the space.

Preferably, the liquid reservoir may surround the liquid-receiving container.

Beneficially, the cookware device may further comprise a vapour permeable support positionable in the food-receiving container, the vapour permeable support for supporting food thereon and allowing vapour to pass through to cook the food.

Optionally, the food-receiving container may be removable from the liquid-receiving container. This may be more convenient for cleaning purposes.

The invention will now be more particularly described, by way of example only, with reference to the accompanying drawings, in which:

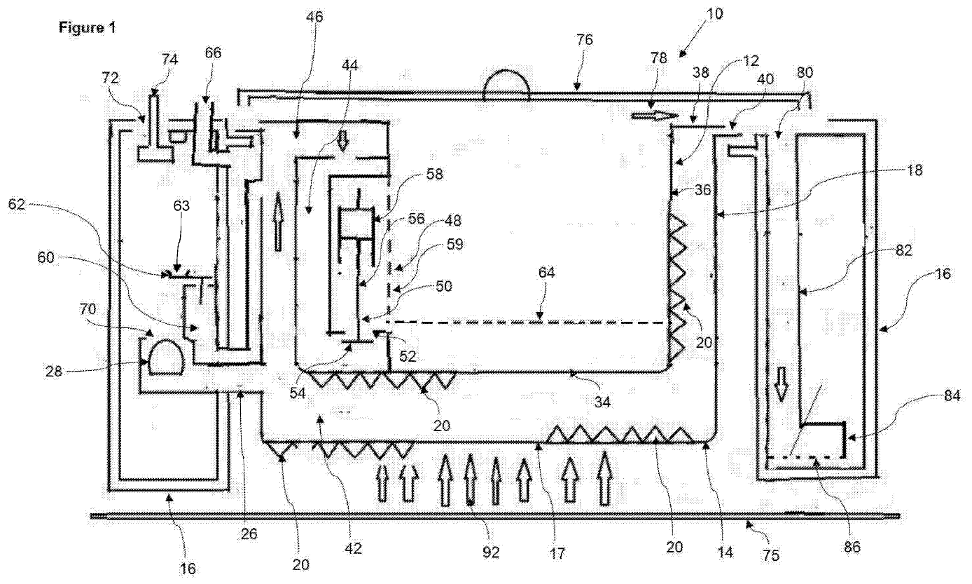

FIG. 1 shows a cross-sectional view of a first embodiment of a cookware device in accordance with a first aspect of the invention;

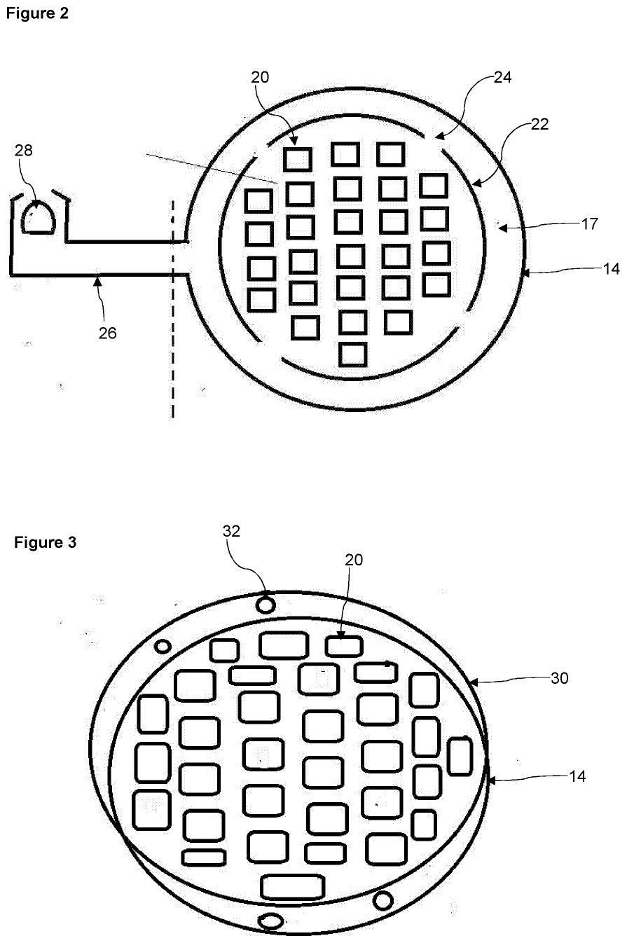

FIG. 2 shows a representation of an interior of a bottom portion of a liquid-receiving container of the cookware device of FIG. 1;

FIG. 3 shows a representation of an exterior of the bottom portion of FIG. 2;

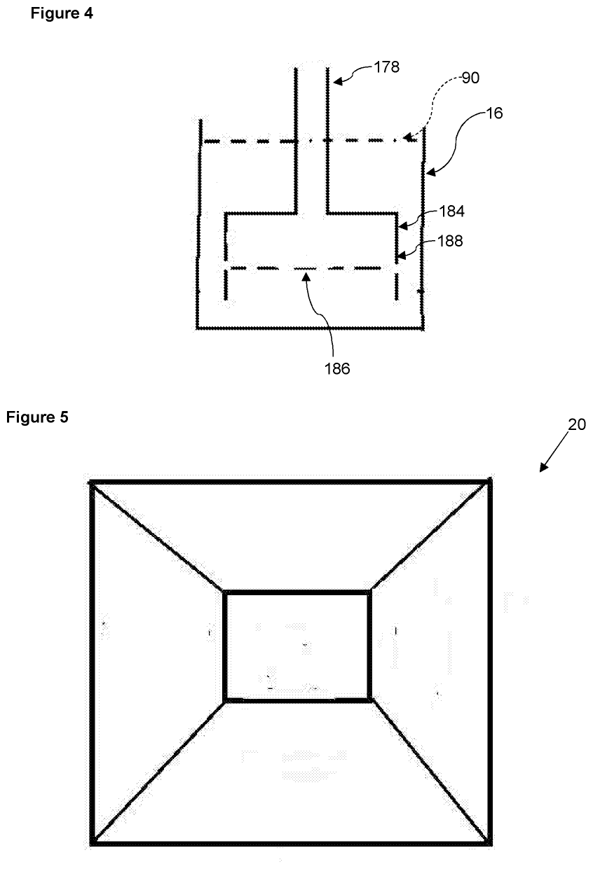

FIG. 4 shows an enlargement of a second embodiment of a vapour diffuser for the cookware device of FIG. 1;

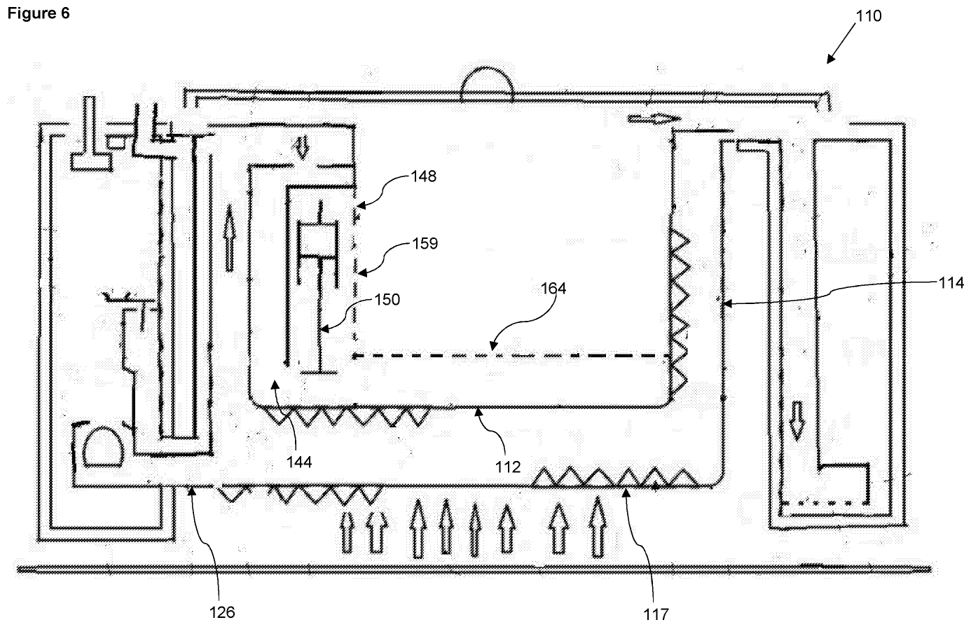

FIG. 5 Shows an End View of a Heat Exchanger;

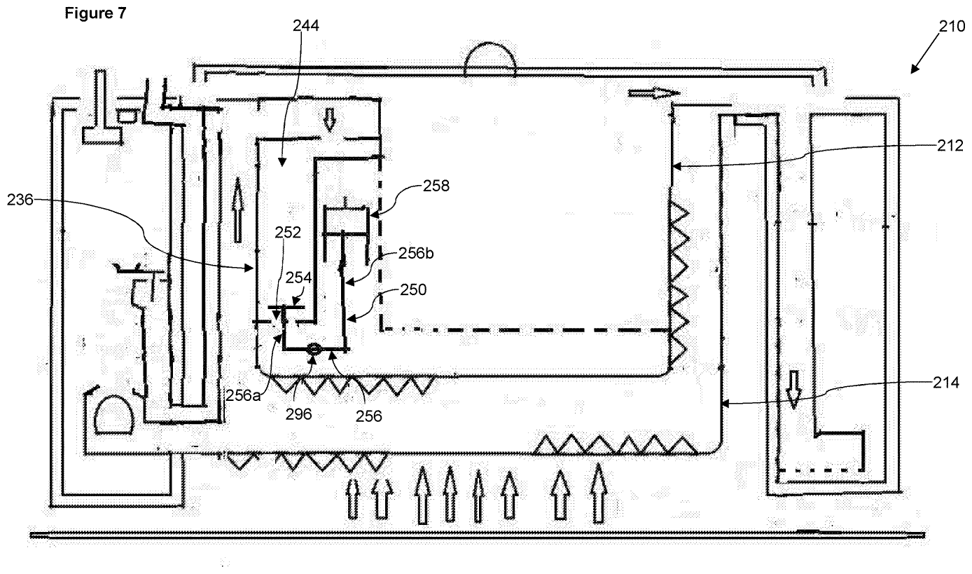

FIG. 6 shows a cross-sectional view of a second embodiment of a cookware device in accordance with a first aspect of the invention; and

FIG. 7 shows a cross-sectional view of a third embodiment of a cookware device in accordance with a first aspect of the invention.

Referring firstly to FIG. 1, there is show an embodiment of a cookware device 10 comprising a food-receiving container 12, a liquid-receiving container 14, and a liquid reservoir 16. The cookware device 10 is here a cooking pot, although it will be appreciated that similar principles may apply to other items of cookware.

The liquid-receiving container 14 may otherwise be referred to as an outer container or outer chamber. The liquid-receiving container 14 has a liquid-receiving-container wall, which is made up of a base 17 and a contiguous sidewall 18. An exterior or outward surface of the base 17 may be a heat-receiving surface of the liquid-receiving container 14.

The liquid-receiving container 14 may have a conventional pot shape, and therefore may have a circular base 17 and a cylindrical sidewall 18. However, it will be appreciated that other geometries may be considered.

The liquid-receiving container 14 preferably has heat exchanger elements 20 on the exterior surface of the base 17 and on an interior surface of the base 17. Here the heat exchanger elements 20 are protrusions, and in particular pyramidal protrusions. In FIG. 1, the pyramidal protrusions are only shown as extending along part of the base 17; however, it will be appreciated that the pyramidal protrusions may extend across the substantially the entire base 17, or at least a majority of the base 17. The shape of the heat-exchanger will be described in greater detail hereinbelow.

Referring now in addition to FIG. 2, the interior surface of the base 17 of the liquid-receiving container 14 may have a wall 22 which surrounds the heat exchanger elements 20 to encourage liquid to stay in contact with the heat exchanger elements 20. The wall 22 may have holes or openings 24 therein to allow movement of liquid therethrough. FIG. 2 also shows a conduit 26 with a floating valve 28, the purpose of which will be better understood hereinbelow.

Referring in addition to FIG. 3, the exterior surface of the base 17 of the liquid-receiving container 14 may have a wall 30 which surrounds the heat exchanger elements 20 to encourage hot air to remain in contact with the heat exchanger elements 20. The wall 30 has openings such as circular apertures 32 for allowing the movement of air therethrough.

Referring back to FIG. 1, the food-receiving container 12 has a similar shape to, and a smaller diameter than, that of the liquid-receiving container 14. Thus, the food-receiving container 12 is receivable at least partly inside the liquid-receiving container 14. The food-receiving container 12 may therefore be an inner container or inner chamber. The food-receiving container 12 has a food-receiving-container wall which includes a base 34 and a contiguous sidewall 36.

The food-receiving container 12 has a radially extending or projecting lip 38 at or adjacent to a top thereof which is receivable on a rim 40 of the liquid-receiving container 14. Since the food-receiving container 12 preferably also has a shorter height than that of the liquid-receiving container 14, when the food-receiving container 12 is supported by its lip 38 resting on the rim 40 of the liquid-receiving container 14, there is clearance between the base 34 of the food-receiving container 12 and the base 17 of the liquid-receiving container 14. The diameters of the containers are also configured such that there is clearance between the sidewall 36 of the food-receiving container 12 and the sidewall 18 of the liquid-receiving container 14.

At least part of this clearance defines a liquid-receiving volume 42 for receiving liquid, which is water.

The lip 38 resting on the rim 40 preferably forms a seal or substantial seal, which may be a liquid-tight and/or vapour-tight seal. As such, vapour may not escape from the liquid-receiving volume 42 via the lip 38 and rim 40.

At the sidewall 36 of the food-receiving container 12, there is a conduit or duct 44 for transferring vapour from at or adjacent to an exterior of the top of the food-receiving container 12, to the interior of the food-receiving container 12. As such, here the duct 44 has an upper opening 46 at the liquid-receiving volume 42 at or adjacent to the top of the sidewall 18 of the food-receiving container 12. The duct 44 has a lower opening 48 below the upper opening 46 and at the interior of the food-receiving container 12.

The duct 44 includes a food-receiving-container valve 50 to close the duct 44 in the event of a high level of liquid in the food-receiving container 12. Preferably the food-receiving-container valve 50 is a floating valve, and more preferably the floating valve is adjustable so that a level of liquid which triggers the closure of the valve can be set.

Here a valve arrangement of the food-receiving container 12 includes a partition in the duct 44 with an upwardly facing opening 52 in the partition. At an upstream side of the partition there is a barrier element 54 which is for closing the opening 52. An arm 56 extends upwardly, but downstream, from the barrier element 54 and through the opening 52. A float 58 is attached to the arm 56 downstream of the partition, and the float 58 is configured to be sufficiently buoyant so as to lift the arm 56 and barrier element 54 when floating. The float 58 is moveable on the arm 56 so that a user can set the vertical position of the float 58 so as to set the level of liquid in the food-receiving container 12 which will cause the float 58 to rise and close the food-receiving container 12.

Downstream of the partition, at least a portion of the lower opening 48 has a removable grill or mesh 59 thereacross. The grill 59 or mesh allows for liquid and vapour to pass through, but prevents food from passing into the duct 44 and occluding the duct 44 or disrupting the floating valve 58. The grill 59 is preferably removeable so as to allow access to the floating valve 58 for manual adjustment.

The duct 44 preferably has a U-shape or substantial U-shape, the partition being towards the bottom of the downstream side of the U-shape.

The liquid-receiving container 14 further includes a pressure relief arrangement for releasing pressure, particularly when the food-receiving-container valve 50 closes the duct 44. The pressure relief arrangement includes a pressure relief conduit 60 which is closeable via a pressure operated valve 62, also referred to as a pressure relief valve. This is such that when there is a higher pressure in the pressure relief conduit 60 than in the liquid reservoir 16 at the pressure operated valve 62. A portion of the pressure relief conduit 60 proximal to the liquid-receiving volume 42 may be narrower than a portion at the pressure operated valve 62.

Here the pressure relief conduit 60 extends to the liquid reservoir 16 and is fluidly communicated therewith. The pressure operated valve 62 closes an opening between the liquid reservoir 16 and the pressure relief conduit 60. The pressure operated valve 62 comprises a pivotable flap for closing the opening.

The pressure relief arrangement may also act as a whistling means, or whistle, for alerting the user when the level of liquid in the liquid reservoir 16 has reached a low level. As the liquid is being drawn into the liquid-transfer conduit 26, the liquid level in the liquid reservoir 16 descends and so liquid may no longer be pressing on the exterior surface of the pivotable flap. In addition, the pivotal flap may include a counterweight which comprises an open container 63 for receiving liquid. Therefore, the open container 63 would hold water despite the liquid level dropping, meaning that the open container 63 is heavy and causes the pivotal flap to open the pressure relief conduit 60, creating a whistling sound. The pressure relief conduit 60 may be shaped so as to generate such a whistling sound, and/or there may be a whistling means in the liquid reservoir 16 which activates upon entry of steam into the liquid reservoir 16.

There is preferably a removeable vapour permeable support 64 positionable in the food-receiving container 12. The vapour permeable support 64 is for supporting food thereon and allowing vapour to pass therethrough to cook the food. The vapour permeable support 64 may be a grill, grid or mesh, for example, and may be supported on the base 34 of the food-receiving container 12. Vapour may pass beneath and through the vapour permeable support 64 without first passing through the grill 59, which occupies at least a portion of the lower opening 48 of the duct 44, due to a lowermost portion of the lower opening 48 being unoccupied by the grill 59. Additionally or alternatively, the vapour permeable support may be connected to, or a one-piece with, the grill 59. This may allow for ease of removal.

An exterior surface of the base 34 of the food-receiving container 12 has heat exchangers thereon, and the sidewall 18 may similarly have heat exchangers. The heat exchanger may be similar or identical to the heat exchangers of the liquid-receiving container 14.

The liquid reservoir 16 is for providing liquid, which is here water, to the liquid-receiving container 14. The liquid reservoir 16 may otherwise be referred to as a liquid jacket. The liquid reservoir 16 is mechanically secured at or adjacent to a top of the liquid-receiving chamber 14.

The liquid reservoir 16 may surround the liquid-receiving container 14, although with a separation between the liquid reservoir 16 and the liquid-receiving container 14, forming a void or space. The space may extend around the liquid-receiving container 14, and there may be a breather or vent 66 for ventilating the space. Such ventilation may be particularly for allowing carbon dioxide to be removed from the space.

The liquid reservoir 16 defines a chamber for receiving liquid therein. This chamber is communicated with the liquid-receiving volume 42 via a liquid-transfer conduit 26 or pipe which bridges the space. The liquid-transfer conduit 26 defines a port which communicates the liquid-receiving volume 42 and the liquid reservoir 16. A bottom of the conduit 26 is shown as being at a different level to a base of the liquid-receiving container 14. It is possible, and preferable, that the bottom of the conduit 26 may be level with the base of the liquid-receiving container 14.

The port is openable and closeable via the floating valve 28. Preferably, the liquid-transfer conduit 26 has an opening 70 at the liquid reservoir 16, a normal direction of the opening 70 being aligned with a vertical direction in use. The floating valve 28 is positioned below the opening 70 so that when a liquid level rises the opening 70 is closed. The floating valve 28 should be made from a material which is buoyant in water.

The liquid reservoir 16 further includes a liquid inlet 72 for filling the reservoir with liquid. The liquid inlet 72 is preferably at an upper surface of the liquid reservoir 16. There may be a floating level indicator 74 which has a shaft which is extendable through the liquid inlet 72. The height at which the shaft extends through the liquid inlet 72 may indicate the level of the liquid reservoir 16.

The liquid reservoir 16 may extend down to a vertically lower level in use than the base 17 of the liquid-receiving container 14, so that the liquid-receiving container 14 may be received on a heat source, such as a hob, whilst the liquid jacket is rested on a slightly lower surface which surrounds the hob. Additionally, for example when positioned on an insulating board 75, shown for reference in FIG. 1 only, resting insulator, or other surface, the heat exchanger elements 20 on the underside of the liquid-receiving container 14 are not required to be in contact with the ground.

The liquid reservoir 16 may be coated in, or otherwise comprise, insulating material, so that the liquid reservoir 16 can retain heat energy for a longer duration. This particularly applies to the external facing surfaces of the liquid reservoir 16. Also, the area of liquid reservoir 16, inside the void or space may be coated with heat insulating means, or a heat insulation coating. The cookware device 10 may also include an external insulating cover which covers the cookware device 10 when not in use to retain stored heat further inside the liquid reservoir 16.

The cookware device 10 further includes a lid 76 which may close a main opening of the food-receiving container 12 and the liquid-receiving container 14. The lid 76 includes a handle.

The device 10 includes a vapour return route 78, along which vapour may flow from the food-receiving container 12 and back to the liquid reservoir 16. The vapour return route 78 is partly defined by a lower surface of the lid 76 when positioned on the food-receiving container 12 and the liquid-receiving container 14. Here the lid 76 extends across the food-receiving container 12 and over a portion of the liquid reservoir 16. Said portion of the liquid reservoir 16 includes an opening 80 in an upper surface thereof. As such, the lid 76 defines a passageway from the food-receiving container 12 and into the liquid reservoir 16. The lid 76 helps to form a conduit between the food-receiving container 12 and the liquid reservoir 16 which bridges the space between the food-receiving container 12 and the liquid reservoir 16. The steam is thus directed from the food-receiving container 12 to the liquid reservoir 16 along the vapour return route 78.

The vapour return route 78 further includes a duct 82 which extends down into the liquid reservoir 16, the duct 82 being terminated in a vapour diffuser 84, distributor, or pressuriser.

The vapour diffuser 84 includes a plate 86 having a plurality of apertures therein so that vapour may be distributed smoothly and evenly across the liquid reservoir 16.

Referring now to FIG. 4, there is shown a second embodiment of a vapour diffuser 184 in the liquid reservoir. The second embodiment of the vapour diffuser 184 includes a narrow conduit which forms part of the vapour return route 178. At a lower end portion of the conduit there is an abrupt flared portion 188. The flared portion includes a plate 186 having a plurality of apertures therein.

Referring now to FIG. 5, there is shown an end view of a representative example of one of the heat exchanger elements 20. The heat exchanger element 20 preferably has a shape corresponding to a pyramidal frustrum, although other shapes may be considered. The pyramidal frustrum preferably has a square base.

The base may have a surface area of 1 cm² . The total exposed surface area of the heat exchanger element 20 may be 4.25 cm², for example, with the top having a surface area of 0.25 cm², and each of the four sides having a surface area of 1 cm².

Alternatively, each of the four sides may have a surface area of 2 cm² so that the total exposed surface area is 8.25 cm².

The smaller heat exchangers may be used on interior surfaces, and the larger heat exchangers may be used on exterior surfaces. The dimensions of the heat exchanger elements 20 have been chosen since the heating time may be reduced to approximately a tenth of what is normally possible.

In use, the height of the float 58 on the arm 56 of the food-receiving-container valve 50 of the food-receiving container 12 should be set so that the food-receiving-container valve 50 only closes when a suitable amount of water is received in the food-receiving container 12. For example, if the user wishes to boil food in the food-receiving container 12, then the float 58 should be set to a high level on the arm 56 so that the food-receiving-container valve 50 only closes when a high level of water is received in the food-receiving container 12. The user can add some water into food receiving container 12 to speed up water condensation to raise water level to required level.

To set the float 58 on the arm 56, the user should first open the grill 58, grid or mesh, move or slide the float 58 along the arm 56 to the determined position, and then replace the grill 59.

The user may then place food in the food-receiving container 12, for example on the vapour permeable support 64. Cooking liquid, such as water, may also be positioned in the food-receiving container 12. The lid 76 should then be positioned over the food-receiving container 12, completing the vapour-return route.

Liquid, in particular water, should then be used to fill the liquid reservoir 16. This may be done via pouring water in through the liquid inlet 72. Once the liquid reservoir 16 is sufficiently filled with water, the liquid level indicator 74 may float 58 and thereby indicate this to a user. Water may then enter the liquid-receiving container 14 via the liquid-transfer conduit 26. Once the liquid level in the liquid-receiving container 14 is sufficient such that the floating valve 28 floats and closes the opening 70 in the liquid-transfer conduit 26, the liquid-receiving container 14 is closed to further liquid ingress.

The cookware device 10 may then be placed on or over a heat source 92 indicated by block arrows in FIG. 1. For example, the base 17 of the liquid-receiving container 14 may be placed on a hob, such as on a gas hob having a gas flame. This may cause the water in the liquid-receiving container 14 to heat, which may in turn heat the food-receiving container 12. The heat exchanger elements 20 may assist with the transferral of heat.

The heat source 92 may also act to heat the liquid reservoir 16.

The air in the void between the liquid reservoir 16 and the liquid-receiving container 14 may be vented via the vent 66, in particular the carbon dioxide may be vented via the vent 66.

The heating water in the liquid-receiving container 14 may also produce steam. The movement of steam is shown in block arrows. The steam may travel up sides of the liquid-receiving container 14, and enter the duct 44 at the side of the food-receiving container 12. The steam may travel down through the duct 44, past the food-receiving-container valve 50, through the grill 59, and into the food-receiving container 12. The steam may act to cook the food received therein.

The steam may then pass along the vapour return route 78 and back into the liquid reservoir 16, being diffused by the vapour diffuser 84. The vapour diffuser 84 may allow the steam to be gently distributed and depressurised, and may condense.

During use, steam which has entered the food-receiving container 12 may condense as water in the food-receiving container 12. This may cause the water level in the food-receiving container 12 to rise. Once the water level has reached the float 58 of the valve arrangement of the food-receiving container 12, the float 58 may buoyantly rise and may lift the barrier element 54 so as to close the opening in the partition, and thus close the food-receiving-container valve 50.

Whilst this prevents too much water being received in the food-receiving container 12, the closure of the valve may cause the pressure to rise in the liquid-receiving volume 42 of the liquid-receiving container 14. Once the pressure in the liquid-receiving volume 42 and pressure relief conduit 60 has reached a level such that a force on the pivotable flap from a side of the pressure relief conduit 60 is greater than the force on the other side of the pivotable flap generated by the water pressure of the liquid reservoir 16, the pivotable flap may open. This allows for discharge of excess pressure into the liquid reservoir 16, which may be open to the atmosphere via the liquid inlet 72.

In the instance that the water level in the liquid receiving conduit 26 falls beneath the pivotal flap, the remaining water in the open container 63 may act as a counterweight to open the pivotal flap, the water pressure on the surface of the pivotal flap having been removed, and generate a whistling noise. This alerts the user that the liquid reservoir 16 needs to be refilled.

The food can be cooked in this manner, and heat energy may be recycled into the liquid reservoir 16, which may act as a heat reservoir. The lid 76 may be removed to access the food in the food-receiving container 12.

After use, the cookware device 10 may be positioned on the resting insulator or insulating mat and covered with the external insulating cover. This may preserve heat energy in the cookware device 10 so that the device can be more quickly and efficiently reheated subsequently.

The food-receiving container 12 may be removed from the liquid-receiving container 14 to assist with cleaning.

It will be appreciated that the food-receiving container 12 may have a different shape to suit different foods. The food-receiving container 12 may be like a cage, mesh, or grid for steaming or steam-cooking foods like eggs, carrots and potatoes. The food-receiving-container valve 50 may not be required for such an arrangement.

For cooking thick liquid foods, such as porridge, the vapour return route 78 and the valve arrangement of the food-receiving container 12 may be omitted. For water boiling, the cookware device 10 may be accompanied by a special food-receiving container 12 which may be without the valve arrangement. This special food-receiving container 12 may have its own cover. This cover may have a whistle, appropriate handle, and may define part of the vapour return route 78. The vapour return route 78 may be used to pour boiling water.

The aforementioned cookware device 10 is preferably for use with an external heat source 92. However, the cookware device 10 may include an electric heater for heating the liquid. For example, there may be an electrical heating element in the liquid reservoir 16 for heating the liquid. In this instance, an insulating base 17 may be affixed to the underside of the cookware device 10, since heating via an external heat source 92 is not required. Additionally, the heat exchange elements may be omitted.

Referring now to FIG. 6, there is shown a second embodiment of a cookware device 110. The second embodiment 110 is similar or identical to the first embodiment 10.

This is with the exception that the liquid-transfer 126 is at or adjacent to the base 117 of the liquid-receiving container 114. A bottom of the liquid-transfer 126 may be level with the base 117.

Additionally, in the second embodiment, the vapour permeable support 164 and the grill or mesh 159 of the second opening 148 of the duct 144 may be interconnected and/or a one-piece. The vapour permeable support 164 and the grill or mesh 159 may be removeable to allow access to the food-receiving-container valve 150.

The duct 144 may also fluidly communicate with the interior of the food-receiving container 112, underneath the vapour permeable support 164.

As such, the food-receiving-container valve 150 may be configured to only reduce fluid communication between the liquid-receiving container 114 and the interior of the food-receiving container 112. This is since the food-receiving-container valve 150 may only close the fluid communication between the liquid-receiving container 114 and the grill or mesh 159 of the second opening 148.

Referring now to FIG. 7, there is shown a third embodiment of a cookware device 210. The third embodiment 210 is similar or identical to the second embodiment 110.

This is with the exception of a modified food-receiving-container valve 250 and duct 244 configured to close fluid communication between the liquid-receiving container 214 and the interior of the food-receiving container 212.

Here the duct 244 includes a partition which is at or adjacent to sidewall 236 of the food-receiving container 212. The partition includes an upwardly facing opening 252.

The arm 256 of the food-receiving-container valve 250 is pivotably mounted to the food-receiving container 212 about a pivot point 296. The arm 256 extends inwards and outwards from the pivot point 296, relative to the food-receiving-container valve 250.

The barrier element 254 is flexibly connected to an outward portion of the arm 256 via a first connecting portion 256a. The first connecting portion 256a may be flexibly connected to both the arm 256 and to the barrier element 254. The barrier element is positioned at an upstream side of the partition.

The float 258 may be flexibly connected to an inward portion of the arm 256 via a second connecting portion 256b. The float 258 is adjustably positionable along at least part of the length of the second connecting portion 256b. The second connecting portion 256b may be flexibly connected to both the arm 256 and to the float 258.

When the float 258, which is in the food-receiving-container valve 250, is raised by the level of the water, it will cause the barrier element 254 to descend, and thereby occlude the upwardly facing opening 252. This can close or limit fluid communication between the liquid-receiving container 214 and the interior of the food-receiving container 212.

It is therefore possible to provide a cookware device which includes a food-receiving container inside a liquid-receiving container so that the temperature inside the food-receiving container does not reach above 100° C. so that the production of cancer causing chemicals is prevented or limited. The use of a liquid reservoir communicated with the liquid-receiving container allows the liquid-receiving container to be replenished as it uses water.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A cookware device comprising:
a food-receiving container for receiving food for cooking, the food-receiving container having a food-receiving-container wall;
a liquid-receiving container which has a liquid-receiving-container wall, the food-receiving container configured to be received by the liquid-receiving container to define a liquid-receiving volume between the food-receiving-container wall and the liquid-receiving-container wall;
a liquid reservoir for holding liquid, the liquid reservoir being liquidly communicated with the liquid receiving volume by a port, the port being configured to be closed and opened by a valve.

2. The cookware device as claimed in claim 1, wherein the valve is a floating valve so that the port is configured to be closed when a given volume of liquid is received in the liquid receiving volume.

3. The cookware device as claimed in claim 1, wherein the liquid receiving volume is in fluid communication with an interior of the food-receiving container.

4. The cookware device as claimed in claim 3, wherein said fluid communication is via an opening any one of at and adjacent to an in-use top of the food-receiving container, and a duct which extends to an interior of the food-receiving container.

5. The cookware device as claimed in claim 3, wherein said fluid communication is configured to be closed via a floating valve in the food-receiving container.

6. The cookware device as claimed in claim 1, further comprising a further port between the liquid reservoir and the liquid receiving volume, said further port being closed by a pressure relief valve configured to allow venting of vapour from the liquid receiving volume into the liquid reservoir.

7. The cookware device as claimed in claim 6, wherein the pressure relief valve comprises a flap configured to be pivoted, the flap configured to close the further port when the pressure of vapour from the liquid receiving volume is less than the pressure in the liquid reservoir at the flap, and to open the further port when the pressure of vapour from the liquid receiving volume is greater than the pressure in the liquid reservoir at the flap.

8. The cookware device as claimed in claim 7, wherein the pressure relief valve comprises an open-topped container configured to bias the flap to an open condition when a level of liquid falls below the pressure relief valve in the liquid reservoir.

9. The cookware device as claimed in claim 1, further comprising a vapour flow path from the food-receiving container to the liquid reservoir to define a vapour return route.

10. The cookware device as claimed in claim 9, wherein the vapour return route includes a vapour diffuser.

11. The cookware device as claimed in claim 9 further comprising a lid configured to close the food-receiving container, the vapour flow path being at least partly defined by an interior facing surface of the lid.

12. The cookware device as claimed in claim 11, wherein the liquid reservoir includes an opening in an in-use upper surface thereof and a conduit-which extends therefrom and to at least an in-use lower half of the liquid reservoir, the device configured so that the lid is positionable across the food-receiving container and said opening to at least partly define the vapour flow path.

13. The cookware device as claimed in claim 1, further comprising a plurality of heat exchanger elements on at least any one of an outer surface of the liquid-receiving-container wall, an inner surface of the liquid-receiving-container wall, and an outer surface of the food-receiving-container wall.

14. The cookware device as claimed in claim 13, wherein each heat exchanger element is a pyramidal protrusion.

15. The cookware device as claimed in claim 1, wherein the liquid-receiving container comprises a wall surrounding at least part of an exterior surface of a base thereof configured to encourage hot air to distribute across the exterior surface of the base.

16. The cookware device as claimed in claim 1, wherein the liquid-receiving volume comprises a wall surrounding an interior surface of a base-thereof configured to encourage hot liquid to distribute across the interior surface of the base.

17. (canceled)

18. The cookware device as claimed in claim 1, wherein a space is defined between the liquid-receiving container and the liquid reservoir, the port being at a conduit which bridges the space.

19. The cookware device as claimed in claim 18, wherein the space includes a breather for ventilating the space.

20. The cookware device as claimed in claim 1, further comprising a vapour permeable support configured to be positioned in the food-receiving container, the vapour permeable support configured to support food thereon and allow vapour to pass through to cook the food.

21. The cookware device as claimed in claim 18, wherein the food-receiving container is configured to be removed from the liquid-receiving container.
